(19) United States
(12) Patent Application Publication
(10) Pub. No.: US 2006/0110600 A1
(43) Pub. Date: May 25, 2006

(54) Anisotropic conductive adhesive composition

(75) Inventors: Glen Connell, Pine Springs, MN (US); Michael A. Kropp, Cottage Grove, MN (US); Eric G. Larson, Lake Elmo, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/992,931

(22) Filed: Nov. 19, 2004

(51) Int. Cl. B32B 27/38; C08L 63/00; B32B 37/00

(52) U.S. Cl. 428/414; 428/413; 523/427; 525/523

(57) ABSTRACT

The invention provides anisotropically conductive adhesive compositions which comprise a mixture of: a cycloaliphatic epoxide resin; an omega hydroxyl ester-modified phenoxy resin; optionally, a multifunctional glycidyl ether epoxide resin; optionally, a thermoplastic resin; thermally activated catalyst; and electrically conductive particles.

### BACKGROUND

The present invention relates to anisotropically conductive adhesives and adhesive compositions.

An adhesive that has the ability to establish multiple, discreet electrical connections between two electrical components is commonly referred to as an anisotropically conductive adhesive. Such adhesives are typically used to provide electrical connection between a flexible circuit and an electrical substrate.

Current anisotropically conductive adhesives are typically latent catalyzed epoxy-resin based adhesives, for example, imidazole catalyzed epoxy-resin based adhesive containing a thermoplastic component and electrically conductive particles. These adhesives require cure temperatures of at least 180° C. and bond times of at least 10 seconds.

### SUMMARY

In one embodiment, the invention provides an adhesive composition comprising a mixture of: a cycloaliphatic epoxide resin; an omega hydroxyl ester-modified phenoxy resin; optionally, a multifunctional glycidyl ether epoxide resin; optionally, a thermoplastic resin; thermally activated catalyst; and electrically conductive particles.

In another embodiment, the invention provides a curable adhesive film comprising the adhesive composition above.

In another embodiment, the invention provides a tape comprising a curable adhesive film of the invention on a liner.

In another embodiment, the invention provides a flexible circuit comprising a flexible printed circuit and an adhesive composition according to the invention adhered to the flexible printed circuit.

### DETAILED DESCRIPTION

“Thermoplastic resin” means a resin that softens when exposed to heat and returns to its original condition when cooled to room temperature.

“Catalytically-effective amount” means a quantity sufficient to effect polymerization of the curable composition to a polymerized product at least to a degree to cause an increase in viscosity of the composition under the conditions specified.

“Parts by weight” (pbw) means parts of a resin component per weight of the total amount of cycloaliphatic epoxide, omega hydroxyl ester-modified phenoxy resin, thermoplastic resin (if present), multifunctional glycidyl ether epoxide resin (if present) and catalyst.

The adhesive compositions of the invention advantageously provide lower bonding temperatures, faster cure rates, and stable and reliable electrical and adhesion properties.

The cycloaliphatic epoxide resin used for the invention is an epoxide resin with an average of at least two epoxy groups per molecule. As examples of cycloaliphatic epoxide resins, there may be mentioned the following that have two epoxy groups in the molecule: vinylcyclohexene dioxide, 3,4-epoxycyclohexylmethyl-3,4-epoxycyclohexanecarboxylate, bis(3,4-epoxycyclohexylmethyl)adipate, and 2-(3,4-epoxycyclohexyl-5,5-spiro-3,4-epoxy) cyclohexane-meta-dioxane. Polyfunctional cycloaliphatic epoxide resins having 3, 4, or more epoxy groups in the molecule (for example, EPOLIDE GT, available from Daicel Chemical Industries, Ltd.) may also be used. Monofunctional cycloaliphatic epoxide resin may also be used, for example, cyclohexene oxide, in combination with di- and multifunctional cycloaliphatic epoxide resins. However, the average functionality of the cycloaliphatic epoxide resin portion of the adhesive composition of the invention should be at least two.

The cycloaliphatic epoxide resin used for the invention has epoxy equivalents in the range of usually about 90 to about 500, about 100 to about 400, about 120 to about 300, and about 210 to about 235. In other embodiments, the cycloaliphatic epoxide resin has epoxy equivalents of less than about 500, less than about 400, less than about 300, and less than about 150.

The cycloaliphatic epoxide resin is present in the adhesive compositions of the invention at an amount from about 10 to about 50 pbw. In other embodiments, the adhesive compositions of the invention contain from about 10 to about 45 pbw cycloaliphatic epoxide resin. Other adhesive compositions of the invention may contain any amount or any range of amount between 10 and 50 pbw cycloaliphatic epoxide resin.

The omega hydroxyl ester-modified phenoxy resins have pendant branches with terminal primary hydroxyl groups resulting from random grafting of an omega hydroxyl ester precursor, for example, e-caprolactone monomer, grafted onto the phenoxy backbone. Useful omega hydroxyl ester-modified phenoxy resins include those having the formula:

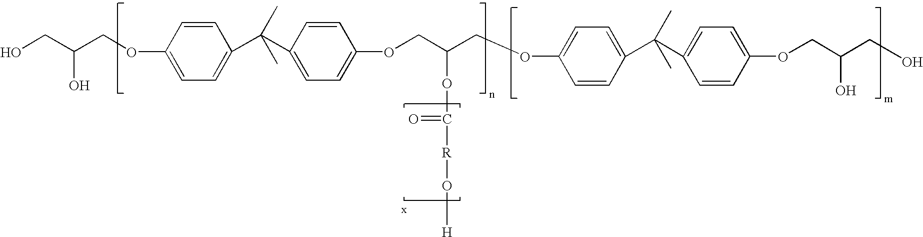

wherein n+m is >40 and x is <3, typically x is about 1 or 2, and R is a difunctional radical having from 2 to 12 carbon atoms.

In another embodiment, the omega hydroxyl ester-modified phenoxy resins include those having the formula:

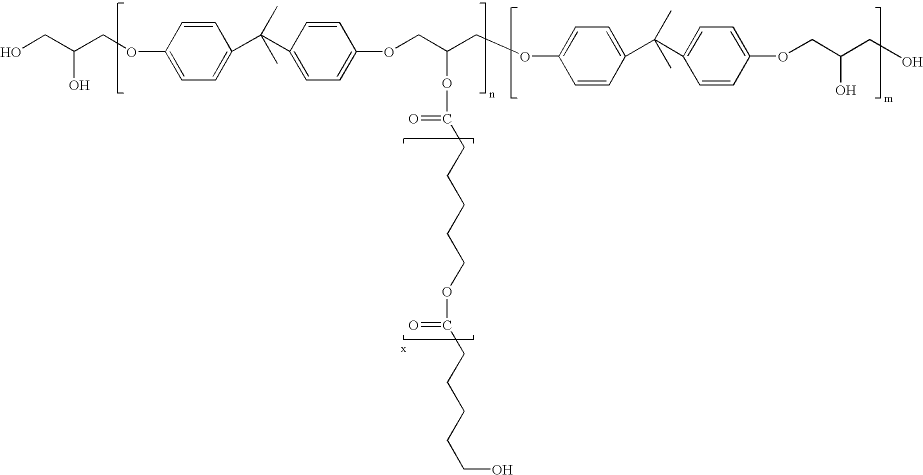

wherein n+m is >40 and x is <3, typically x is about 2.

The omega hydroxyl ester-modified phenoxy resin is present in the adhesive compositions of the invention at an amount from about 10 to about 50 pbw. In other embodiments, the adhesive compositions of the invention contain from about 10 to about 45 pbw omega hydroxyl ester-modified phenoxy resin. Other embodiments of the adhesive compositions of the invention may contain any amount or any range of amount between 10 and 50 pbw omega hydroxyl ester-modified phenoxy resins.

Useful multifunctional glycidyl ether epoxide resins, if present in the adhesive compositions, include those epoxide resins having more than 2 glycidyl groups on average within a molecule. Specific examples of the glycidyl ether epoxide resin include multifunctional phenol novolak-type epoxide resins (synthesized by reacting phenol novolak with epichlorohydrin) cresol novolak epoxide resin, and bisphenol A novolak epoxide resins. Examples of commercially available multifunctional glycidyl ether epoxide resins include EPON 1050, EPON 160, EPON 164, EPON 1031, EPON SU-2.5, EPON SU-3, and EPON SU-8, available from Resolution Performance Products, Houston, Tex.; the “DEN” series of epoxide resins, available from Dow Chemical, Midland Mich.; and TACTIX 756 epoxide resin, available from Huntsman Chemical, East Lansing, Mich. The multifunctional glycidyl ether epoxide resins as described herein exclude cycloaliphatic epoxide resins.

The multifunctional glycidyl ether epoxide resin usually has an epoxy equivalent weight of from about 170 to about 500, in other embodiments, from about 170 to about 350, and in other embodiments from about 170 to about 250. Ranges for the average epoxide functionality include from 2.5 to 10, in other embodiments, from 3 to 9, and in other embodiments, from 4.5 to 9.

The multifunctional glycidyl ether epoxide resin is present in the adhesive compositions of the invention at an amount from 0 to about 50 pbw. In other embodiments, the adhesive compositions of the invention contain from about 20 to about 40 pbw multifunctional glycidyl ether epoxide resin. Other adhesive compositions of the invention may contain any amount or any range of amount between 0 and 50 pbw multifunctional glycidyl ether epoxide resin.

The thermoplastic oligomeric or polymeric resins, if present in the adhesive compositions, useful in the anisotropically conductive adhesive compositions are film formers and in some cases permit rework of a bond using an appropriate solvent. The thermoplastic resins include those semi-crystalline materials that have melting points. Useful thermoplastic resins are essentially free of groups that would interfere with the cationic polymerization of the epoxy functional resins. More particularly, useful thermoplastic resins are essentially free of nucleophilic groups, such as amine, amide, nitrile, sulfur or phosphorus functional groups. Furthermore, suitable thermoplastic resins are soluble in solvents such as tetrahydrofuran (THF) or methyl ethyl ketone (MEK) and exhibit an initial compatibility with the epoxide resin used. This compatibility allows the blend of epoxide resin and thermoplastic resin to be solvent cast without phase separating. Nonlimiting examples of thermoplastic resins having these characteristics and useful in this invention include polyesters, co-polyesters, acrylic and methacrylic resins, phenoxy resins (excluding omega hydroxyl ester-modified phenoxy resins), and novolac resins. It is also within the scope of this invention to use a blend of more than one thermoplastic oligomeric or polymeric resin in preparing the adhesive compositions.

The thermoplastic resin is present in the adhesive compositions of the invention at an amount from 0 to about 20 pbw. In other embodiments, the adhesive compositions of the invention contain from about 1 to about 10 pbw thermoplastic resin. Other embodiments of the adhesive compositions of the invention may contain any amount or any range of amount between 0 and 20 pbw thermoplastic resin.

Examples of useful thermally activated catalyst are quaternary ammonium salts having the formula: 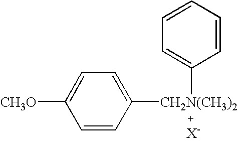
wherein X⁻ is a non-interfering anion having the formula DQₙ⁻, wherein D is a metal from Groups 8 to 11 or a metalloid from Groups 13 to 15 of the Periodic Table of the Elements (IUPAC version), Q is a halogen atom, and n is an integer having a value of from 1 to 6. Desirable metals are copper, zinc, titanium, vanadium, chromium, magnesium, manganese, iron, cobalt, or nickel. Useful metalloids are boron, aluminum, antimony, tin, arsenic, and phosphorous. In some embodiments, Q is chlorine or fluorine. Exemplary non-interfering anions are BF₄⁻, PF₆⁻, SbF₆⁻, FeCl₄⁻, SnCls₅⁻, AsF₆⁻, SbF₅⁻OH⁻, SbCl₆⁻, SbF₅⁻², AlF₅⁻², GaCl₄⁻, InF₄⁻, TiF₆⁻², ZrF₆⁻², and CF₃SO₃⁻. Desirable non-interfering anions are BF₄⁻, PF₆⁻, SbF₆⁻, FeCl₄⁻, SnCl₅⁻, AsF₆⁻, SbF₅OH⁻; more desirably, PF₆⁻, SbF₆⁻, SbF₅OH⁻.

Quaternary ammonium salts of this type may be prepared by methods described in, for example, U.S. Pat. No. 5,070,161 (Nakano et al.), the disclosure of which is incorporated herein by reference, or may be obtained from commercial sources (e.g., under the trade designation “NACURE XC-7231”, available from King Industries, Inc., Norwalk, Conn.). Analyses using infrared and nuclear magnetic resonance spectroscopy of the quaternary ammonium salt marketed under the trade designation “NACURE XC-7231” indicated that a useful quaternary ammonium salt is (4-methoxybenzyl)dimethylphenylammonium hexafluoroantimonate.

The thermally activated catalyst is present in the adhesive compositions in a catalytically effective amount. Thermally activated catalyst can be present in an amount in the range of from about 0.01 to about 10 pbw; in other embodiments from about 0.01 to about 5 pbw; in other embodiments, from 0.1 to about 3 pbw. Thermally activated catalyst may also be present in any amount or range of amounts between 0.01 and 10 pbw.

The electrically conductive particles used may be conductive particles such as carbon particles or metal particles of silver, copper, nickel, gold, tin, zinc, platinum, palladium, iron, tungsten, molybdenum, solder or the like, or particles prepared by covering the surface of these particles with a conductive coating of a metal or the like. It is also possible to use non-conductive particles of a polymer such as polyethylene, polystyrene, phenol resin, epoxide resin, acryl resin or benzoguanamine resin, or glass beads, silica, graphite or a ceramic, whose surfaces have been covered with a conductive coating of a metal or the like.

The electrically conductive particles are found in a variety of shapes (spherical, ellipsoidal, cylindrical, flakes, needle, whisker, platelet, agglomerate, crystal, acicular). The particle may have a slightly rough or spiked surface. The shape of the electrically conductive particles is not particularly limited but a nearly spherical shape is usually preferred. The choice of shape is typically dependent upon the rheology of the selected resin components and ease of processing of the final resin/particle mix. Combinations of particle shapes, sizes, and hardness may be used in the compositions of the invention.

The mean particle size of the conductive particles used may vary depending on the electrode width and the spacing between the adjacent electrodes used for connection. For example, if the electrode width is 50 micrometers and the spacing between adjacent electrodes is 50 micrometers (i.e., the electrode pitch is 100 micrometers), a mean particle size of about 3 to about 20 micrometers is appropriate. By using an anisotropically conductive adhesive composition in which are dispersed conductive particles with a mean particle size in this range, it is possible to achieve fully satisfactory conductive characteristics while also adequately preventing short circuiting between adjacent electrodes. In most cases, since the pitch of the electrodes used for connection between the two circuit substrates will be from about 50 to about 1000 micrometers, the mean particle size of the conductive particles is preferably in the range of about 2 to about 40 micrometers. If they are smaller than about 2 micrometers, they may be buried in pits in the electrode surface thus losing their function as conductive particles, and if they are larger about 40 micrometers, they may tend to produce short circuiting between adjacent electrodes.

The amount of the conductive particles added may vary depending on the area of the electrodes used and the mean particle size of the conductive particles. A satisfactory connection can usually be achieved with a few (for example, about 2 to about 10) conductive particles present per electrode. For even lower electrical resistance, the conductive particles may be included in the composition at about 10 to about 300 per electrode.

The amount of conductive particles with respect to the total volume of the composition minus the conductive particles is usually about 0.1 to about 30% by volume, in other embodiments about 0.5 to about 10% by volume and in other embodiments, about 1 to about 5% by volume.

In one embodiment of the invention, an adhesive composition comprises a cycloaliphatic epoxide resin, an omega hydroxyl ester-modified phenoxy resin, thermally activated catalyst, and electrically conductive particles. In this embodiment, polyfunctional cycloaliphatic epoxide resins having 3, 4, or more epoxy groups in the molecule are desirable to use in the composition. In such compositions, the cycloaliphatic epoxide resin and the omega hydroxyl ester-modified phenoxy resin are present in a weight ratio of about 1: 1, and in other embodiments, from about 0.9:1 to about 1:1.1 weight ratio.

Adjuvants may optionally be added to the compositions such as colorants, antioxidants, flow agents, bodying agents, flatting agents, silane coupling agents, bi-functional resins, such as an oxetane derivative available as CYRACURE UVR-6000 cycloaliphatic epoxide diluent, available from The Dow Chemical Co., and epoxidized tetrahydrobenzyl alcohol, available from Daicel Chemical Industries, Ltd., inert fillers, binders, blowing agents, fungicides, bactericides, surfactants, plasticizers, rubber tougheners, and other additives known to those skilled in the art. They can be also substantially unreactive, such as fillers both inorganic and organic. These adjuvants, if present, are added in an amount effective for their art known purpose and are essentially free of nucleophilic groups.

The amount of heat required for polymerization and the catalytically effective amount of the initiator system used will vary depending on the particular polymerizable composition used and the desired application of the polymerized product. Suitable sources of heat to cure the compositions of the invention include induction heating coils, hot bar bonders, ovens, hot plates, heat guns, IR sources including lasers, microwave sources, etc.

Typically, the adhesive composition of the invention will be solvent or hot-melt coated onto a release liner and used as a transfer adhesive film such that the adhesive film can be adhered to a substrate and the liner removed. A typical use for the anisotropically conductive adhesives described herein is to provide a connection between a flexible printed circuit and a circuit board, for example those found in a flat panel display. Other potential applications include flipchip attachment of unpackaged silicon chips to various printed circuit substrates and interconnections between two flexible printed circuits or any combinations thereof. Suitable substrates useful to provide articles of the invention include, for example, metals (for example, aluminum, copper, cadmium, zinc, nickel, gold, platinum, silver), glass, various thermoplastic or thermoset films (for example, polyethylene terephthalate, plasticized polyvinyl chloride, polypropylene, polyethylene), ceramics, cellulosics, such as cellulose acetate, and epoxides (circuit boards).

Advantages of this invention are further illustrated by the following examples, but the particular materials and amounts thereof recited in these examples, as well as other conditions and details, should not be construed to unduly limit this invention. All materials are commercially available or known to those skilled in the art unless otherwise stated or apparent.

### EXAMPLES

In the test methods and examples below, the sample dimensions are approximate.

### Test Methods

Electrical Resistance

A 28 mm wide by 22 mm long by 25 microns thick polyimide flexible circuit having 101 traces that were gold over nickel over copper, obtained from Flex Circuits Incorporated, Minneapolis, Minn., was removed from a drying oven set at 80° C. The traces were 100 microns in width with 100 microns spacing and a height of no greater than 18 microns. An approximately 30 mm long strip of the film composition to be tested was cut from a film sample that had a liner on both sides of the film. One of the liners was removed and the exposed side of the film was tacked to the flexible circuit by rolling with a roller to ensure smooth application and eliminate any entrapped air. The excess sample film was trimmed to the edge of the flexible circuit to form a film/flexible circuit laminate. The remaining liner was carefully removed without disturbing the film bond to the flexible circuit.

A 46 mm wide by 76 mm long by 1.4 mm thick FR4 printed circuit board with the same traces as the flexible circuit, available from Nationwide Circuits Inc., Rochester, N.Y., was removed from a drying oven set at 80° C. The film/flexible circuit laminate was placed on the circuit board making sure that each trace of the film/flexible circuit laminate was aligned properly with each trace of the printed circuit board and rolled down with a roller to ensure smooth application and eliminate any entrapped air. A strip, approximately 50 mm long, of the FujiPoly Sarcon 20GTR thermally conductive rubber, available from FujiPoly America Corporation, Carteret, N.J., was laid over the bond area of the joined sample.

A MicroJoin 4000 pulse heat bonder, manufactured by MicroJoin Inc. (now Unitek Miyachi Corporation, Monrovia, Calif.) with a 2 mm wide thermode was used to make the bond. The bonder was setup to achieve a measured temperature of 160° C. (thermocouple) in the bond line for 10 seconds and a pressure of 2 MPa. The resultant connection area for each trace was 100 microns by 2 mm. The bonded samples were aged for about 16 hours at ambient conditions.

Electrical resistance of the bonded samples was determined using a 4-Point Kelvin Measurement technique using the following components/settings:

Power source/voltmeter=Model 236 Source-Measure Unit, available from Keithley Instruments, Inc., Cleveland, Ohio

Switching matrix=Integra Series Switch/Control Module Model 7001, available from Keithley Instruments, Inc.

Probe station=Circuit Check PCB-PET, available from Circuit Check Inc, Maple Grove, Minn.

PC software=LabVIEW

Test current=100 milliamps (mA)

Sense compliance (volts)=2.000

Max. Measurable resistance=20.000 ohms

The bonded samples were placed in the probe station, and 15 measurements were taken on each sample.

After the bonded samples were tested for Electrical Resistance at room temperature, they were then placed into an accelerated aging chamber at 85° C. and 85% relative humidity (RH). After 100, 250, 500, and 1000 hours, the bonded samples were taken out of the chamber, allowed to equilibrate to room conditions for at least two hours and then tested for electrical resistance.

90 Degree Peel Adhesion

Bonded samples were prepared as described above for test method “Electrical Resistance”.

The bonded samples were tested for 90 degree peel adhesion using an INSTRON 1122 Tensile Tester upgraded with MTS ReNew™, available from MTS Systems Corporation, Eden Prairie, Minn., fitted with a 50 lb. Load cell, and a 90 degree peel test fixture. The peel rate was 25 mm/minute. The peak peel value was recorded in grams per centimeter (gf/cm). One to three replicates were tested for each test composition. The peak peel values of the replicates were averaged and reported as the peak peel value for each composition.

The following examples were conducted using the materials shown in Table 1 below.

TABLE 1

| Trade Designation/ | | |
|---|---|---|
| Material | Source | Description |
| Thermoplastic Resin | | |
| Hytrel ™ 4056 | DuPont Company, | Butylene/Poly(alkylene ether) |
| | Willmington, Delaware | phthalate thermoplastic |
| | | polyester elastomer, MW |
| | | Tg = −50° C. |
| Epoxide Resin | | |
| Cyracure ™ UVR-6110 | Dow Chemical Co., | 3,4-epoxycyclohexylmethyl- |
| | Midland, Michigan | 3′,4′-epoxycyclohexane |
| | | carboxylate; liquid |
| | | cycloaliphatic epoxide resin, |
| | | average epoxy functionality 2 |
| ERL 4221 | Dow Chemical Co., | 3,4-epoxycyclohexylmethyl- |
| | Midland, Michigan | 3′,4′-epoxycyclohexane |
| | | carboxylate; liquid |
| | | cycloaliphatic epoxide resin, |
| | | average epoxy functionality 2 |
| Epon ™ Resin 164 | Resolution Performance | Solid multifunctional ortho- |
| | Products, Houston, | cresol epoxy novolac, epoxy |
| | Texas | functionality 5.6, epoxy group |
| | | content (EGC) 4165-5000, |
| | | average number of repeating |
| | | phenolic units in the molecule |
| | | (n) 3.6 |
| Epon ™ Resin SU-8 | Resolution Performance | Polymeric solid |
| | Products, Houston, | multifunctional epoxy |
| | Texas | novolac resin, average |
| | | epoxide group functionality |
| | | about 8, wt. per epoxide 195-230, |
| | | melting point (Mettler) |
| | | 82° C. |
| Phenoxy Resin | | |
| InChemRez ™ PKCP- | InChem Corp., Rock | Solid caprolactone-grafted |
| 80 | Hill, South Carolina | phenoxy resin, Tg (DSC) |
| | | 30° C., OH number (calc.) |
| | | 155-160 |
| InChemRez ™ PKCP- | InChem Corp., Rock | Semi-solid caprolactone- |
| 67 | Hill, South Carolina | grafted phenoxy resin, Tg |
| | | (DSC) 2° C., OH number |
| | | (calc.) 130-135 |
| InChemRez ™ PKHB | InChem Corp., Rock | Solid phenoxy resin, Tg |
| | Hill, South Carolina | (DSC) 84° C., Melt Index @ |
| | | 200° C. 60 g/10 min |
| Electrically | | |
| Conductive Particles | | |
| 7GNM8-Ni | JCI USA Inc., White | 7 wt. % gold-coated nickel |
| | Plains, New York | particles, average mean size 8 |
| | | microns |
| HDNP - 400 Mesh | Novamet Specialty | Nickel particles, average |
| | Products Corporation, | mean size 12 microns |
| | Wyckoff, New Jersey | |
| Thermally Activated | | |
| Catalyst | | |
| Nacure ™ XC-7231 | King Industries Inc, | Quaternary ammonium |
| | Norwalk, Connecticut | hexafluoroantimonate |

### Example 1

In an open vessel, 15 g cycloaliphatic epoxide resin (Cyracure™ UVR6110), 15 g phenoxy resin (InChemRez™ PKCP-80), and 15 g multifunctional epoxide resin (Epon™ Resin SU-8) were blended together by hand at a temperature of 150° C. The blend was allowed to cool at ambient conditions to about 70° C.

To 10 g of the above cooled blend were added 1.3 g electrically conductive particles (7GNM8-Ni) and 0.1 g catalyst (Nacure™ XC-7231). A 75 micron thick film was prepared by placing the composition onto a release coated polyethylene terephthalate (PET) film liner and drawing through a knife heated to 70 ° C.

The film was tested for Electrical Resistance according to the test method outlined above. Three electrical samples were made with the 15 connections per sample for a total of 45 connections. Average initial resistance was 7.1 milliohms.

### Example 2

A composition was prepared containing a thermoplastic resin.

In an open vessel, 2.3 g thermoplastic resin (Hytrel™ 4056), 13.2 g cycloaliphatic epoxide resin (Cyracure™ UVR-6110), 12.0 g phenoxy resin (InChemRez™ PKCP-80), and 14.8 g multifunctional epoxide resin (Epon™ Resin SU-8) were blended together by hand at a temperature of 170° C. The blend was allowed to cool at ambient conditions to about 70° C.

To 10 g of the above cooled blend were added 2.0 g electrically conductive particles (7GNM8-Ni) and 0.10 g catalyst (Nacure™ XC-7231) and mixed by hand until a uniform composition was obtained. A 40 micron thick film was prepared by placing the composition onto a release coated polyethylene terephthalate (PET) film liner and drawing through a knife heated to 70° C.

The film was tested for Electrical Resistance according to the test method described above. Results are given in Table 2.

TABLE 2

| | Electrical | | Aged 100 | Aged 250 | Aged 500 | Aged 1000 |
|---|---|---|---|---|---|---|
| | Resistance, | | hours | hours | hours | hours |
| Example | milliohms | Initial | 85° C./85% RH | 85° C./85% RH | 85° C./85% RH | 85° C./85% RH |
| 2 | Average | 9.4 | 13 | 14 | 14 | 15 |

### Examples 3-4 and Comparative Example 1

Three compositions were prepared using various phenoxy resin components.

Examples 3 and 4 contained modified phenoxy resins and Comparative Example 1 contained an unmodified phenoxy resin as the phenoxy resin component. The films were prepared according to Example 1 using the components and amounts in Table 3.

TABLE 3

| | | | Comparative |
|---|---|---|---|
| Component | Example 3 | Example 4 | Example 1 |
| Hytrel 4056 | 4 | 4 | 4 |
| Cyracure UVR-6110 | 26 | 26 | 26 |
| Epon SU-8 | 26 | 26 | 26 |
| InChemRez PKCP- | 26 | — | — |
| 67 | | | |
| InChemRez PKCP- | — | 26 | — |
| 80 | | | |
| InChemRez PKHB | — | — | 26 |
| 7GNM8-Ni | 16 | 16 | 16 |
| Nacure XC-7231 | 1 | 1 | 1 |

The films were tested for 90 Degree Peel Adhesion according to the test method outlined above. Results are given in Table 4.

TABLE 4

| Example | Average Peel Adhesion, gf/cm |
|---|---|
| 3 | 950 |
| 4 | 1280 |
| Comp. 1 | 1050 |

### Examples 5-10

Six compositions were prepared as follows using varying amounts of cycloaliphatic resin, multifunctional epoxide resin, and phenoxy resin components.

In an open vessel, the components and amounts as specified in Table 5 were together by hand at a temperature of 150° C. -170° C. The blend was allowed to ambient conditions to about 70° C.

TABLE 5

| | | | Amount | Amount |
|---|---|---|---|---|
| | Amount Hytrel | Amount ERL | InChemRez | Epon |
| Example | 4056, g | 4221, g | PKCP-80, g | 164, g |
| 5 | 5 | 35 | 25 | 40 |
| 6 | 5 | 30 | 30 | 40 |
| 7 | 5 | 45 | 25 | 30 |
| 8 | 5 | 35 | 45 | 20 |
| 9 | 5 | 45 | 35 | 20 |
| 10 | 5 | 30 | 45 | 25 |

To 10 g of the above cooled blend were added 2 g electrically conductive particles (HDNP-400 Mesh) and 0.1 g catalyst (Nacure™ XC-7231) and mixed by hand until a uniform composition was obtained. A 75 micron thick film was prepared by placing the composition onto a release coated paper liner and drawing through a knife heated to 70° C.

The films were tested for initial Electrical Resistance and 90 Degree Peel Adhesion according to the test methods outlined above. The median electrical resistance and average peel adhesion are given in Table 6.

TABLE 6

| | Median Initial Electrical | Average Peel Adhesion, |
|---|---|---|
| Example | Resistance, milliohms | gf/cm |
| 5 | 23 | 454 |
| 6 | 95.3 | 580 |
| 7 | 15.3 | 646 |
| 8 | 205 | 812 |
| 9 | 17.4 | 824 |
| 10 | 93 | 833 |

Foreseeable modifications and alterations of this invention will be apparent to those skilled in the art without departing from the scope and spirit of this invention. This invention should not be restricted to the embodiments that are set forth in this application for illustrative purposes.

What is claimed is:

1. An adhesive composition comprising a mixture of:
a cycloaliphatic epoxide resin;
an omega hydroxyl ester-modified phenoxy resin;
optionally, a multifunctional glycidyl ether epoxide resin;
optionally, a thermoplastic resin;
thermally activated catalyst; and
electrically conductive particles.

2. The adhesive composition according to claim 1 wherein the multifunctional glycidyl ether epoxide resin is present in the composition.

3. The adhesive composition according to claim 1 wherein the multifunctional glycidyl ether epoxide resin and the thermoplastic resin are present in the composition.

4. The adhesive composition according to claim 1 wherein the thermoplastic resin is present in the composition.

5. The adhesive composition according to claim 1 further comprising a silane coupling agent.

6. The adhesive composition according to claim 3 wherein the thermoplastic resin is selected from the group consisting of polyesters, co-polyesters, acrylic resins, methacrylic resins, phenoxy resins, novolac resins, and blends thereof.

7. The adhesive composition according to claim 3 wherein the thermoplastic resin is a copolyester.

8. The adhesive composition according to claim 1 wherein the cycloaliphatic epoxide resin has epoxy equivalents in the range of about 90 to about 500.

9. The adhesive composition according to claim 1 wherein the cycloaliphatic epoxide resin has epoxy equivalents of less than about 150.

10. The adhesive composition according to claim 1 wherein the cycloaliphatic epoxide resin has an epoxide functionality of 2 or greater.

11. The adhesive composition according to claim 1 wherein the multifunctional glycidyl ether epoxide resin has an epoxide functionality of greater than 2.

12. A curable adhesive film comprising the adhesive composition of claim 1.

13. The curable adhesive film according to claim 12 wherein the adhesive film has a thickness of from 5 to 100 micrometers.

14. A tape comprising the curable adhesive film of claim 12 on a liner.

15. A sheet comprising the curable adhesive film of claim 12 on a liner.

16. A flexible circuit comprising a flexible printed circuit and the adhesive composition according to claim 1 adhered to the flexible printed circuit.

17. The adhesive composition according to claim 1 wherein the cycloaliphatic epoxide resin has an epoxide functionality of 3 or greater.

18. The adhesive composition according to claim 1 wherein the cycloaliphatic epoxide resin is present in the adhesive composition in an amount from about 10 to about 50 pbw.

19. The adhesive composition according to claim 1 wherein the omega hydroxyl ester-modified phenoxy resin is present in the adhesive composition in an amount from about 10 to about 50 pbw.

20. The adhesive composition according to claim 1 wherein the cycloaliphatic epoxide resin is present in an amount from 30 to 35 pbw, wherein the omega hydroxyl ester-modified phenoxy resin is present in an amount from 30 to 35 pbw, wherein the multifunctional glycidyl ether epoxide resin is present in an amount from 30 to 35 pbw, wherein the thermoplastic resin is present in an amount from 3 to 7 pbw, wherein the catalyst is present in an amount from 0.3 to 3 pbw, and electrically conductive particles is present in an amount of from 1 to 5 percent by volume.
